(19) United States
(12) Patent Application Publication
(10) Pub. No.: US 2006/0121169 A1
(43) Pub. Date: Jun. 8, 2006

(54) Artistic pasta and method of making

(76) Inventor: Roberta L. Dowling, Winchester, MA (US)

Correspondence Address: MAINE & ASMUS, 100 MAIN STREET, P O BOX 3445, NASHUA, NH, 03061-3445, US

(21) Appl. No.: 11/002,823

(22) Filed: Dec. 2, 2004

(51) Int. Cl. A23L 1/16

(52) U.S. Cl. 426/557

(57) ABSTRACT

Artistic pastas and techniques for making the same. The pastas include a design that is built onto a carrier layer using various colored pasta doughs, where details of the design are selectively colored and shaped, thereby breathing an artistic quality into the pasta. The details of the design may further include differing textures and flavors as well. The resulting pastas are not only aesthetically unique, but have an exclusive mouth-feel as well, thereby enhancing the overall culinary experience. One specific type of this artistic pasta is in the form of a ravioli, with the design built on the top layer of the ravioli. Other types of this artistic pasta are not filled pastas. The artistic pasta can be shaped and designed in accordance with a holiday, special occasion, special event, or the artist's fancy.

### FIELD OF THE INVENTION

The present invention relates to pasta, and more particularly to artistic pasta having one or more designs built thereon.

### BACKGROUND OF THE INVENTION

The term pasta is generally used to describe a wide variety of noodle-like foods made from a particular type of dough. Typically, this dough is made by combining semolina (durum wheat flour) or other flour with water or milk. Some pasta doughs also include egg, while doughs made with only flour and eggs are usually referred to as egg noodles. Spaghettis (e.g., fettuccine, fusilli, gemelli, linguine) and various macaronis (e.g., ditali, elbow, mostaccioli, penne, ribbon, rigatoni, and ziti) tend to be the most popular types of pastas. Other popular pasta types, such as ravioli and tortellini, have fillings. There are numerous other pastas, such as bow-ties/farfalle, corkscrew/rotelle, lasagna, and shells/conchiglie.

Any of these various pastas, which are normally pale white or golden yellow depending on the type of flour and egg content, can be colored through the use of colored ingredients. For instance, beet juice can be added to make the pasta dough red, spinach can be added to make the pasta dough green, and squid ink can be added to make the pasta dough black. Striped or multi-colored pasta can be made by combining different colored pasta doughs prior to formation of the particular pasta being made, so as to provide a single plane of pasta having multiple colors. The shape of pasta can vary as well, and typically results from one or two processes: extruding and rolling.

An extruder-type process presses the pasta dough though plates with variously shaped perforations. The resulting shaped pasta strand that is output from the extruder plate is then cut cross-section wise into individual pasta pieces. The perimeter and perforation detail (if any) of the strand can range from simple round spaghetti to most imaginable shapes and designs that can be realized by an extruder plate. A roller-type process generally makes flat sheets of pasta that can then be cut or molded into a particular shaped pieces. The rollers can include engravings or molds, so that the resulting pasta includes the additional detail of the engraving/mold on its surface (as opposed to just being flat). Plaques are sometimes used, especially in making filled pastas, such as ravioli. Here, a first sheet of rolled pasta dough is laid over the plaque, so that spaced indentations on the plaque surface create pocket sections distributed on the sheet. A filling is then added to those pocket sections. A top sheet of rolled pasta dough is then laid over the lower sheet, thereby covering the filled pockets. Pressure is then applied to the top sheet of pasta (rolling pin or top pressure plate), so as to cause the underlying plaque to seal and cut-out the individual filled pieces of filled pasta.

Regardless of the forming process used, conventional pastas are generally limited to relatively simple designs. For example, conventional extrusion and rolling processes do not allow for pastas having detailed multi-color designs, where select features of each pasta piece are a different color from other features of that pasta piece. Nor do these forming processes allow for multi-layer designs. Moreover, extrusion processes can only yield pastas that are uniform in design, where the extruder plate pattern is consistent throughout the length of the pasta.

What is needed, therefore, are artistic pastas having multi-layer and/or multi-color designs, and techniques for making the same.

### SUMMARY OF THE INVENTION

One embodiment of the present invention provides an artistic pasta that includes a base pasta having a carrier surface. A first design layer is built on the carrier surface, and has at least one feature formed from a first pasta dough that is a different color than the base pasta. In one particular case, the first design layer includes one or more additional features colored differently than the first pasta dough, with each addition feature formed from a correspondingly colored pasta dough. Alterantively, the first design layer may include one or more additional features that are all formed from the first pasta dough. The artistic pasta may further include one or more additional design layers, each having at least one feature formed from one or more respective pasta doughs that are each a different color than the base pasta and the first pasta dough.

For instance, the pasta may further include a second design layer that is built on the first design layer, and has at least one feature formed from a second pasta dough that is a different color than the base pasta and the first pasta dough. Here, the second design layer may include one or more additional features colored differently than the second pasta dough, with each formed from a correspondingly colored pasta dough. Alternatively, the second design layer may include one or more additional features that are all formed from the second pasta dough. The pasta may further include a third design layer that is built on the second design layer, and has at least one feature formed from a third pasta dough that is a different color than the base pasta, the first pasta dough, and the second pasta dough. Here, the third design layer may include one or more additional features colored differently than the third pasta dough, each formed from a correspondingly colored pasta dough. Alternatively, the third design layer may include a plurality of features that are all formed from the third pasta dough.

In one particular case, the base pasta is a ravioli having a top layer, a bottom layer, and a filling sealed therebetween. In this case, the carrier surface is the top surface of the ravioli. Alternatively, the base pasta is a single layer of unfilled pasta dough. The artistic pasta can be shaped and designed, for example, in accordance with a holiday (e.g., Christmas wreath or Easter egg), special occasion (e.g., birthday or anniversary), or special event (e.g., house warming, sporting event, company event). Virtually limitless customized shapes and designs and themes are possible here, and the present invention is not intended to be limited to any particular one. Note that each of the base pasta, the first design layer, and any additional design layers can be made to have a substantially same thickness, which allows one to taste and feel the layers of flavors in the pasta, as they marry when eaten.

Another embodiment of the present invention provides a method for making artistic pasta. The method includes preparing a base pasta having a carrier surface, and building a first design layer on the carrier surface, where at least one feature of the first design layer is formed from a first pasta dough that is a different color than the base pasta. In one particular case, building the first design layer includes adding one or more additional features colored differently than the first pasta dough, each formed from a correspondingly colored pasta dough. Alternatively, building the first design layer may include adding a plurality of features that are all formed from the first pasta dough. The method may further include building one or more additional design layers, each having at least one feature formed from one or more respective pasta doughs that are each a different color than the base pasta and the first pasta dough.

Preparing the base pasta may include, for example, forming top and bottom layers of a ravioli, where the carrier surface is the top layer of the ravioli. Here, the method may further include assembling the ravioli (including its filling) after building the first design layer and any additional design layers on the top layer of the ravioli. The method may further include cooking the artistic pasta, design-side up, in shallow simmering water so that the artistic pasta will not turn over (e.g., until the pasta is al dente). The method may further include coating the first design layer and any additional design layers with egg white prior to cooking the artistic pasta, which will help the artistic pasta stay together during the cooking process.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1a illustrates an artistic pasta configured with a multi-layer colored design in accordance with an embodiment of the present invention.

FIG. 1b illustrates a cross-section view of the pasta shown in FIG. 1a.

FIG. 2a illustrates an artistic pasta configured with a multi-colored design in accordance with an embodiment of the present invention.

FIG. 2b illustrates a cross-section view of the pasta shown in FIG. 2a.

FIG. 3 illustrates an artistic pasta configured with a multi-layer colored design in accordance with another embodiment of the present invention.

FIG. 4 illustrates a method for making artistic pasta configured with a multi-layer and/or multi-colored design in accordance with one embodiment of the present invention.

### DETAILED DESCRIPTION OF THE INVENTION

Fresh pasta or pasta fatta in casa (pasta made at home) or pasta fatta a mano (pasta made by hand) are all one and the same thing. Embodiments of the present invention provide artistic pastas and techniques for making the same. The pastas include a design that is built onto a carrier layer, where details of the design are selectively colored and shaped, thereby breathing an artistic quality into the pasta. The resulting pastas are not only aesthetically unique, but have an exclusive mouth-feel as well, thereby enhancing the overall culinary experience.

In one particular example, a ravioli is provided that has upper and lower layers of pasta and a filling therebetween, as well as a design built onto the upper layer of the ravioli. Red features of the design are built using red pasta dough, blue features of the design are built using blue pasta dough, green features of the design are built using red pasta dough, etc. Edible glue is used to secure the dough pieces of the design in place, and in one instance is egg whites. The design can be one or more layers formed on the upper layer of the ravioli.

Thus, a design is built on a carrier surface of a base pasta, with at least one of the design features formed with a pasta dough that is a different color than the carrier surface pasta. Each layer of the design can include multiple colors or a single color, and may include any number of different or like features, including textures (e.g., seeds) and flavors (e.g., spices). Note also that the perimeter of the base pasta can have any of numerous conventional or fanciful shapes as well, further adding to the overall design of the artistic pasta.

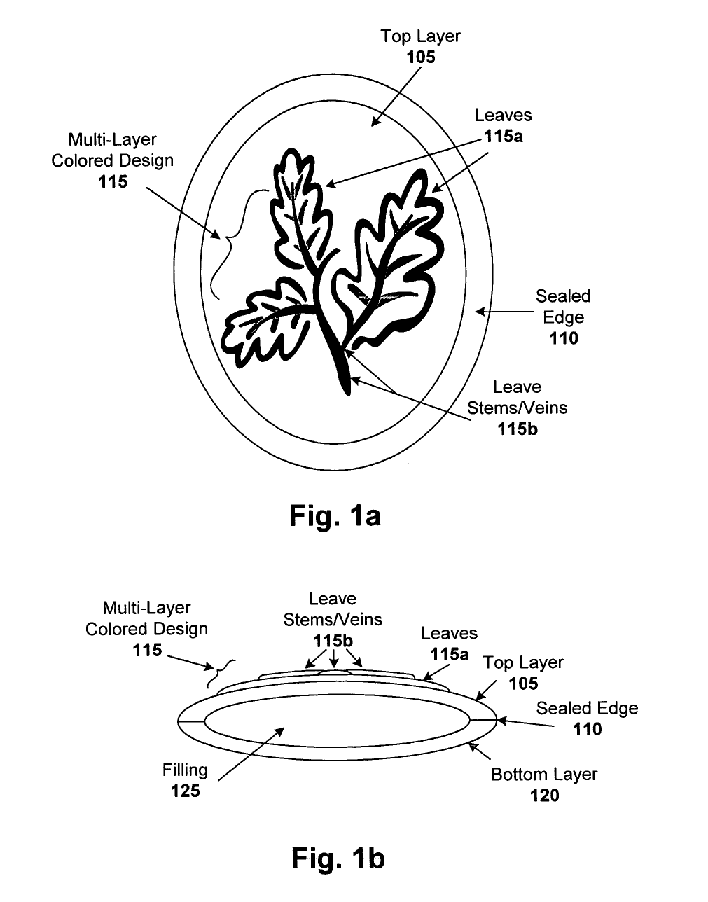

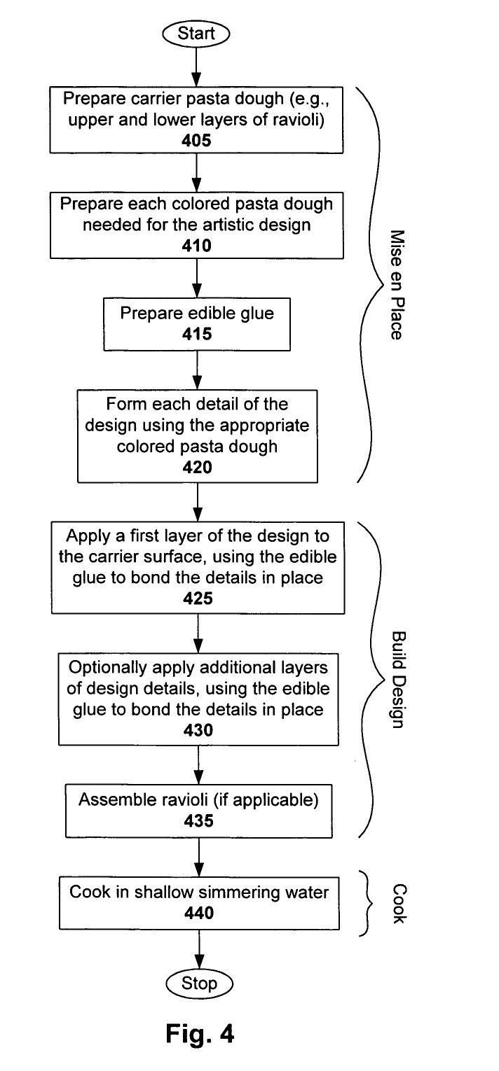

Example artistic designs will now be described with reference to FIGS. 1a-b, 2a-b, and 3, followed by a description of methodologies for creating such designs, including techniques for coloring, shaping, texturing, layering, and constructing the features of the design with reference to FIG. 4.

Example Artistic Designs

FIG. 1a illustrates an artistic pasta configured with a multi-layer colored design in accordance with an embodiment of the present invention. FIG. 1b illustrates a cross-section view of the pasta shown in FIG. 1a.

In this example, the pasta is a ravioli having a top layer 105, a bottom layer 120, and a filling 125. A multi-layer colored design 115 is built onto the top layer 105. In addition, the outer perimeter of the top and bottom layers 105 and 120 is sealed together to provide the sealed edge 110, so as to enclose the filling 125. The perimeter shape of the ravioli is oval in this case, but can be any one of a number of shapes as will be apparent in light of this disclosure.

The multi-layer colored design 115 includes three leaves 115a and the corresponding leave stem/veins 115b. As can be seen in the cross-section view of FIG. 1b, the leaves 115a make up a first layer of the design 115 and the stem/veins 115b make up a second layer of the design 115. Each of the three leaves 115a can be a different color (e.g., red, green, and brown), and is cut from the corresponding colored pasta dough before being placed on the top layer 105. The stem/veins 115b can be, for example, black or another shade of brown pasta dough that is layered onto the top layer 105 and leaves 115a, thereby forming the overall multi-layer colored design 115.

The pasta dough used to make the ravioli top and bottom layers 105 and 120, as well as the design 115 can be made, for example, with any conventional flour, water/milk, and egg recipe. Note, however, that semolina flour may produce a pasta dough that is more difficult to work with than regular white flour, depending on the details and features of the design 115. Techniques for achieving various colors, textures, and flavors within the pasta doughs used to make up the design 115, as well as layers 105 and 120, will be discussed in reference to FIG. 4.

Further note that the design 115 can have a number of layers (e.g., one to five), thereby enabling a virtually unlimited number of aesthetic designs. Also, the thickness of the pasta dough making up each of the major layers of the design 115, as well as layers 105 and 120, can be made substantially consistent (e.g., to a maximum of ⅛ inch). This allows one to taste and feel the layers of flavors and texture in the artistic pasta, as they marry when eaten. Finer features of the design 115 can be sized as necessary to provide a visual impact as well. Egg whites or other edible glue can be used to secure each design feature in its place.

The filling 125 can be, for example, shredded lobster or crab, or a seasoned beef or chicken. Alternatively, the filling 125 can be a cheese, such as ricotta, fontina, or gorgonzola. Alternatively, the filling 125 can be vegetable or herb based, such as seasoned spinach or squash, or dilled shredded carrot. Generally stated, the filling 125 can be any ingredient or combination of ingredients that would provide a desirable filling for the ravioli, and the present invention is not intended to be limited to any one such filling. Moreover, other embodiments of the artistic pasta may not include a filling 125. Here, the artistic pasta may include a multi-layer colored design 115 built on a single base layer of pasta.

To preserve the visual effect of the design 115 when the ravioli is served, the topping could be, for instance, truffle butter, plain butter, or other simple sauce. In this way, the design 115 will not be obfuscated by a thick or otherwise opaque topping when served. Note that the ravioli could be topped with a simple sauce, and the filling 125 could be an opaque sauce (e.g., red marinara sauce) that might otherwise be used as a desirable topping. Thus, the desire to preserve the visual presentation and the desire for a heavier, opaque sauce are both satisfied.

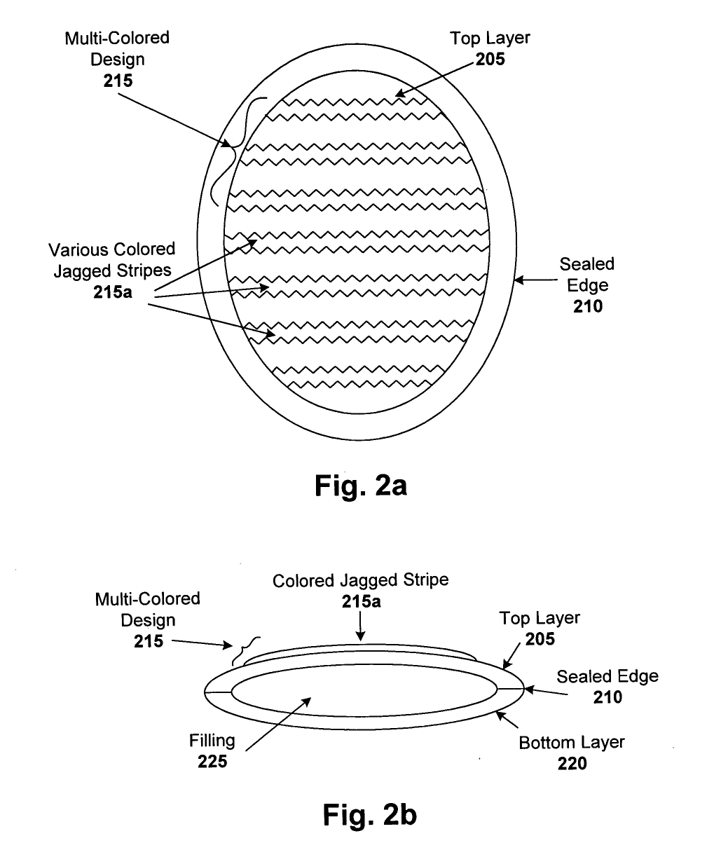

FIG. 2a illustrates another example artistic pasta configured in accordance with an embodiment of the present invention. FIG. 2b illustrates a cross-section view of the pasta shown in FIG. 2a.

In this example, the pasta is a ravioli having a top layer 205, a bottom layer 220, and a filling 225. A multi-colored design 215 is built onto the top layer 205. In addition, the outer perimeter of the top and bottom layers 205 and 220 is sealed together to provide the sealed edge 210, so as to enclose the filling 225. The perimeter shape of the ravioli is oval in this case, but can be any one of a number of shapes as will be apparent in light of this disclosure.

The multi-colored design 215 includes a number of colored jagged stripes 215a laid across the top layer 105, thereby providing a single layer design. Each of the stripes 215a can be a different color (e.g., red, orange, yellow, green, light blue, purple, and brown). Alternatively, the stripes 215a can all be a single color that is different from the color of layer 205. Alternatively, the stripes 215a can be two alternating colors that are each different from the color of layer 205. Numerous color stripe schemes are possible here. In any case, each stripe 215a is cut from the corresponding colored pasta dough before being placed on the top layer 205, thereby forming the overall multi-colored design 215.

The previous description with reference to FIGS. 1a and 1b, is equally applicable here, including descriptions on the pasta dough used to make the artistic pasta, fillings (or lack thereof), coloring/texturing/flavoring techniques, layer thickness, edible glues, and toppings.

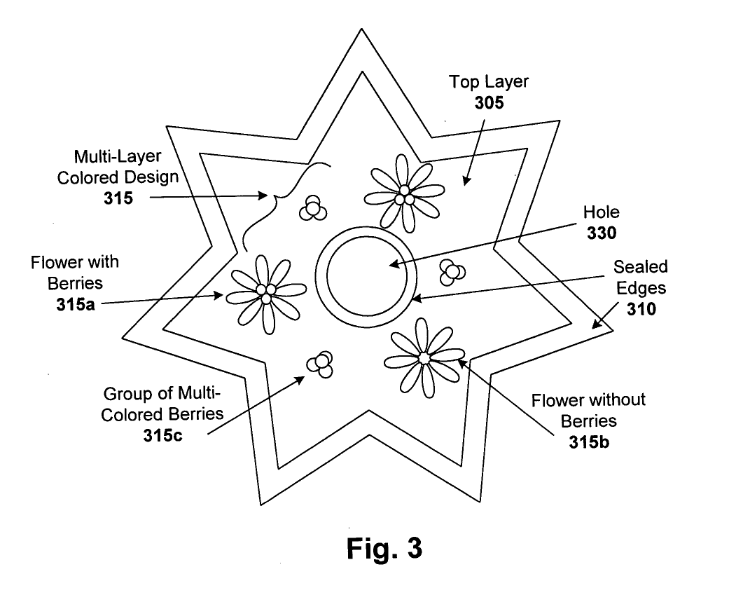

FIG. 3 illustrates another example artistic pasta configured in accordance with an embodiment of the present invention.

In this example, the pasta is a star-shaped ravioli having a top layer 305. The bottom layer and filling of the ravioli are not shown, but will be understood in light of this disclosure. Alternatively, note that the pasta may simply be a star-shaped layer 305 (with not bottom layer or filling). A multi-layer colored design 315 is built onto the top layer 305. Assuming a ravioli, the corresponding outer and inner perimeters of the top layer 305 and the bottom layer are sealed together to provide the inner and outer sealed edges 310, so as to enclose the filling. A hole 330 is provided in the center of this example. Just as with the other examples, the perimeter shape of the ravioli can be any one of a number of shapes, and is not intended to be limited to a star-shape. For example, the perimeter could be round (like a wreath).

The multi-layer colored design 315 includes two flowers with berries 315, one flower without berries 315b, and three groups of stacked berries 315c. In this case, the petals of flowers 315a and 315b, as well as the first floor berries of stacks 315c, make up a first layer of the design 315. The berries of flowers 315a and 315b, as well as the second floor berries of stacks 315c, make up a second layer of the design 315. Each of the flowers 315a and 315b can be a different color, and/or have petals of varying color. The petals are cut from the corresponding colored pasta dough before being placed on the top layer 305. Likewise, the berries of 315a, 315b, and 315c can have any desirable color scheme (e.g., mixed black, red, and green berries), thereby forming the overall multi-layer colored design 315.

The previous description with reference to FIGS. 1a and 1b, is equally applicable here, including descriptions on the pasta dough used to make the artistic pasta, fillings (or lack thereof), coloring/texturing/flavoring techniques, layer thickness, edible glues, and toppings.

Methodology

FIG. 4 illustrates a method for making artistic pasta configured with a multi-layer and/or multi-colored design in accordance with one embodiment of the present invention. As can be seen, the method includes a Mise en Place portion, a build design portion, and cooking portion. Various coloring, texturing, flavoring, and building techniques are described in turn.

The following items and tools are suggested to facilitate carrying out the method: a pasta machine, a bag of flour for dusting the board (or other work surface) and the dough as necessary, a dough scraper to keep the work surface clean of hardened dough particles, several clean dish towels, an exacto utility knife, a pastry wheel (serrated and plain), a garlic press, a pastry brush, a small art paint brush, tweezers, plastic wrap, a spider strainer, a shallow heatproof rectangular pan not more than 4 inches high, water, salt and cookie cutters of different sizes and shapes. Note that these suggestions are not intended in anyway to limit the present invention.

If the artistic pastas are for Christmas, the cutters may include, for example, Christmas trees, angels, snowmen, bells, ornament balls, or gingerbread girls and boys. Square or rectangle shaped cutters resemble presents. Larger round cutters resemble Christmas wreaths, with a smaller round cutter to cut out the center hollow of the wreath. Numerous variations will be apparent here. For instance, if the artistic pastas are for Chanukah, Menorah or Star of David shaped cutters could be used. If the artistic pastas are for Easter, cutters shaped as Easter eggs, doves, rabbits, and Easter baskets could be used. If the artistic pastas are for Halloween or Thanksgiving, cutters shaped as pumpkins, cats, ghosts, turkeys, or acorns could be used. There is virtually no limit to the various cutter designs that can be used here, regardless of the particular holiday season, special occasion, or other special event at hand.

The Mise en Place portion of the method includes preparing 405 the base pasta having a surface to carry the artistic design, and preparing 410 each colored pasta dough needed for the artistic design. Assume for sake of discussion, that the artistic pasta being made is a ravioli in the form of a Christmas wreath. The pasta doughs used can be made, for example, with a typical flour, water/milk, and egg recipe, with colorings and textures added as described herein.

Here, the base pasta can be prepared by rolling out a sheet of spinach pasta the width of the pasta machine, to the thinnest setting. Alternatively, the sheet can be rolled with a rolling pin, to about ⅛ to 1/32 of an inch. Then, two round pieces can be cut out of the sheet with, for example, a 4½ inch round cookie cutter, so as to form top and bottom ravioli sections of the wreath design. A hole can be cut in the center of each round piece using a smaller round cookie cutter (e.g., ¾ inch). Thus, two rounds of dough with a hole in the middle are formed that resemble a wreath. Note that the design is built onto the top layer of the ravioli before filling the ravioli.

Each colored pasta dough of the design can be similarly prepared, where a sheet of the desired thickness is rolled out, and the various design feature shapes are cut out (e.g., using cookie cutters or free form cutting with an exacto knife). There are many color variations possible with different kinds and quantities of herbs, vegetable purees, squid ink, tomato paste, and saffron. For example, green pasta dough can be made with different kinds or green leaves, parsley, sorrel, arugula (rocket), marjoram, hyssop, borage, basil, etc. rendering different shades of green. The pasta can be flavored with, for instance, a single herb such as sage, dill, mint, basil, or rosemary, so that the end result is a speckled, flavored pasta.

Different vegetable purees from which pasta dough can be made include, for instance, red or yellow or green peppers, carrots, spinach, tomatoes, beets, broccoli, mushrooms, peas, squash, black or red beans. Squid ink is also used to make jet-black pasta. When making the colored or flavored pasta dough, the colors may be enhanced or darkened with natural food coloring. Another way of bringing a different dimension and look to the pasta dough is to utilize seeds or spices such as poppy seeds, black pepper, saffron, sesame seeds, or tumeric.

Once the pasta colors and textures are decided and the pasta doughs are made, the Mise en Place portion of the method continues with preparing 415 the edible glue (e.g., egg whites), and forming 420 each detail of the design using the appropriate colored pasta dough. Note that the forming step 420 can also be part of the build design portion of the method, where the design pieces are cut or otherwise formed and then promptly glued in place. In any case, the build design portion of the method continues with applying 425 a first layer of the design to the carrier surface of the base pasta, using the edible glue to bond the details in place. For multi-layer designs, the method further includes applying 430 the additional layers of design details, using the edible glue to bond the details in place.

For example, and continuing with the Christmas wreath example, individual leaves of the wreath can be cut free form from another color of green pasta dough. The underside of each leaf is brushed with egg whites and placed on the previously formed top ravioli portion. Poinsettia flowers can then be cut from red or pink pasta dough, and are applied to the top of the leaves using the same technique to adhere the layers. The layer of leaves constitutes the first design layer of dough placed on top of the original round. The poinsettia flowers are the second design layer. The wreath design may further include a third layer of stamen or pistols, formed with shapes of yellow pasta dough that are secured with egg white to the center of each poinsettia flower.

Thus, there are four layers in total: a round carrier layer forming the general shape of a wreath (top of ravioli), a layer of lighter green shapes to establish leaves on the wreath, a layer of red and pink shapes to create the poinsettia leaves, and a layer of yellow shapes completing the image of the plant. A red ribbon, cut free form from rolled red pasta can be used for a red bow that is secured, for example, to the layer of wreath leaves where there are no poinsettia flowers.

Once the top layer of the ravioli is fully decorated with the multi-layered colored design, the build design portion of the method continues with assembling 435 the ravioli (assuming the artistic pasta is a ravioli). For example, a spoonful of filling (e.g., shredded lobster or crab, or seasoned butter nut squash) is placed on the previously formed round bottom layer of the ravioli. The outer and inner perimeters of the round bottom layer are then moistened with egg white. An artist paint brush can be used to brush egg white all over the bottom layer, up to and around the filling. The round top layer (now decorated with the three layer design) is placed on top of the filling, and is then sealed to the bottom layer at the inner and outer perimeters by the egg whites. The sealed edges can be pressed together with a fork.

This process is repeated until the desired quantity of artistic raviolis is provided. Keeping the raviolis covered until all are filled and formed will help prevent the earlier made raviolis from drying out. Each time a design is placed on a ravioli or other carrier/base layer, it can be sealed with egg whites (prior to cooking) to protect the design and hold it in place during the cooking process.

Once the artistic pasta (in this example case, raviolis) are all built, the method continues with cooking 440 the artistic pasta in shallow simmering water. For instance, in a shallow heatproof roasting pan (e.g., not over 4 inches in height), add just enough water to cover each ravioli, but not so deep as to have the ravioli roll over. Bring the water to a boil, salt it. Reduce the heat so the water is just simmering. Carefully slide the ravioli in the water. Cook until al dente. Because of variation in pasta shapes, thicknesses, and ingredients, as well as outside variables, the cooking time will vary.

Remove the cooked raviolis with a spider strainer (or other suitable instrument) and place on paper towels to drain and absorb excess water. Once the raviolis are placed on individual plates, they can be topped with, for example, truffle butter or other desired sauce. Regardless of the number of layers in the resulting artistic pasta, a consistent thickness of the layers (e.g., to a maximum of ⅛ inch) allows the eater to taste and feel the layers of flavors in the pasta, as they marry when eaten. However, such a consistent thickness in the pasta's layers is not required to practice embodiments of the present invention.

Note that each ravioli prepared may be a different design and/or color with several layers applied to the original base layer so as to add dimensional complexity. Numerous variation in detail will be apparent in light of this disclosure. For example, green pasta dough placed in a garlic press when extruded, looks like pine needles. Each pine needle would be placed on the top layer of the ravioli with tweezers. Candy canes can be created by twisting or overlaying white and red pasta dough on the wreath in select areas. Red berries can also be applied to the wreath with tweezers. Teddy bears can be made from brown pasta dough, with a black nose and a red ribbon formed with corresponding colored doughs.

Easter egg raviolis can be formed using a similar process. For example, the base shape changes from a round to an oval. Decorative options could include items pertaining to Easter, such as small free form flowers and stripes, layering free form bunnies, baskets and eggs. Christmas tree pasta can also be formed using a similar process, with decorative options including a triangular shaped base with one or more layers of green or gold colored garland and multi-colored ornaments.

Note that the designs are not limited to holiday themes. Special occasions and special events can also be represented in a multi-layer and/or colorful pasta design. Example special occasions include anniversaries or birthdays, where the design could include the relevant number of years and colorful surrounding detail (e.g., song birds, ribbons, and presents). A wedding is another special occasion, where the design could include colorful flowers and doves. Example special events include sporting events such as the Super Bowl, where the design could include a multilayer, multi-color Super Bowl design (the number of the Super Bowl and the two team insignias). A house warming gift is another special event, where the design could include the colorful, multi-layer detail of a cozy house. A company function is another special event, where the design could include a colorful and/or multi-layer company logo and recent achievement (e.g., CSCA 30^{th} Anniversary). In general, the design of the artistic pasta can be customized to capture any fanciful or otherwise artistic scene built with multiple pasta doughs of one or more colors that are different from the base pasta.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. An artistic pasta, comprising:
a base pasta having a carrier surface; and
a first design layer built on the carrier surface, and having at least one feature formed from a first pasta dough that is a different color than the base pasta.

2. The pasta of claim 1 wherein the first design layer includes one or more additional features colored differently than the first pasta dough, each formed from a correspondingly colored pasta dough.

3. The pasta of claim 1 wherein the first design layer includes one or more additional features that are all formed from the first pasta dough.

4. The pasta of claim 1 further comprising:
a second design layer built on the first design layer, and having at least one feature formed from a second pasta dough that is a different color than the base pasta and the first pasta dough.

5. The pasta of claim 4 wherein the second design layer includes one or more additional features colored differently than the second pasta dough, each formed from a correspondingly colored pasta dough.

6. The pasta of claim 4 wherein the second design layer includes one or more additional features that are all formed from the second pasta dough.

7. The pasta of claim 4 further comprising:
a third design layer built on the second design layer, and having at least one feature formed from a third pasta dough that is a different color than the base pasta, the first pasta dough, and the second pasta dough.

8. The pasta of claim 7 wherein the third design layer includes one or more additional features colored differently than the third pasta dough, each formed from a correspondingly colored pasta dough.

9. The pasta of claim 7 wherein the third design layer includes one or more additional features that are all formed from the third pasta dough.

10. The pasta of claim 1 wherein the base pasta is a ravioli having a top layer, a bottom layer, and a filling sealed therebetween, and the carrier surface is the top surface of the ravioli.

11. The pasta of claim 1 wherein the base pasta is a single layer of unfilled pasta dough.

12. The pasta of claim 1 wherein the artistic pasta is shaped and designed in accordance with a holiday, special occasion, or special event.

13. The pasta of claim 1 wherein each of the base pasta, the first design layer, and any additional design layers have a substantially same thickness.

14. An artistic pasta, comprising:
a first base pasta layer;
a second base pasta layer having a carrier surface;
a filling enclosed between the first and second base pasta layers;
a first design layer built on the carrier surface, and having at least one feature formed from a first pasta dough that is a different color than the base pasta;
wherein each of the first base pasta layer, second base pasta layer, and first design layer have a substantially same thickness.

15. The pasta of claim 14 wherein the first design layer includes one or more additional features colored differently than the first pasta dough, each formed from a correspondingly colored pasta dough.

16. The pasta of claim 14 wherein the first design layer includes a plurality of features that are all formed from the first pasta dough.

17. The pasta of claim 14 wherein the artistic pasta is shaped and designed in accordance with a holiday, special occasion, or special event.

18. The pasta of claim 14 further comprising:
one or more additional design layers, each having at least one feature formed from one or more respective pasta doughs that are each a different color than the base pasta and the first pasta dough.

19. A method for making artistic pasta, comprising:
preparing a base pasta having a carrier surface; and
building a first design layer on the carrier surface, where at least one feature of the first design layer is formed from a first pasta dough that is a different color than the base pasta.

20. The method of claim 19 wherein building the first design layer includes adding one or more additional features colored differently than the first pasta dough, each formed from a correspondingly colored pasta dough.

21. The method of claim 19 wherein building the first design layer includes adding a plurality of features that are all formed from the first pasta dough.

22. The method of claim 19 further comprising:
building one or more additional design layers, each having at least one feature formed from one or more respective pasta doughs that are each a different color than the base pasta and the first pasta dough.

23. The method of claim 19 wherein preparing the base pasta includes forming top and bottom layers of a ravioli, where the carrier surface is the top layer of the ravioli.

24. The method of claim 23 further comprising:
assembling the ravioli, including its filling, after building the first design layer and any additional design layers on the top layer of the ravioli.

25. The method of claim 19 wherein the first design layer and any layers of the base pasta have a substantially same thickness.

26. The method of claim 19 further comprising cooking the artistic pasta, design-side up, in shallow simmering water so that the artistic pasta will not turn over.

27. The method of claim 19 further comprising coating the first design layer and any additional design layers with egg white prior to cooking the artistic pasta.
